(19) United States
(12) Patent Application Publication
(10) Pub. No.: US 2013/0282894 A1
(43) Pub. Date: Oct. 24, 2013

(54) VALIDATING CONTENT FOR A WEB PORTAL

(71) Applicants: Nimrod Barak, Tel Aviv (IL); Nir Benjamin, Pardes-Hana-Karkur (IL)

(72) Inventors: Nimrod Barak, Tel Aviv (IL); Nir Benjamin, Pardes-Hana-Karkur (IL)

(73) Assignee: SAP PORTALS ISRAEL LTD, Raanana (IL)

(21) Appl. No.: 13/453,316

(22) Filed: Apr. 23, 2012

(51) Int. Cl. G06F 15/173

(52) U.S. Cl. 709/224

(57) ABSTRACT

Techniques for validating web content include identifying web content including web content portions, wherein a particular web content portion includes a content and a format; comparing the format of the particular web content portion against a specified format; and based on the comparison including a difference between the format of the particular web content portion and the specified format, displaying a message indicating the difference between the format of the particular web content portion and the specified format.

### TECHNICAL BACKGROUND

This disclosure relates to validating content for a web portal.

### BACKGROUND

Users can create and/or edit web content that is provided (e.g. displayed) within a portal environment of an organization. Prior to displaying the web content, the web content can be initially sent to an approver (e.g., a manager or IT administrator) for approval for presentation within the portal environment. The approval process for the web content can sometimes be time intensive, and if changes (e.g. fixes) to the web content are required (such as amending the web content to conform to the approver), it may delay having the web content presented within the portal environment.

### SUMMARY

This disclosure describes systems, methods, apparatus, and computer-readable media for validating web content provided to users. In some embodiments, to validate the web content, the web content is initially identified. The identified web content can include web content portions. In some examples, the web content portions include (e.g., are associated with) a content and a format. In some examples, the format describes how the content is visually presented to the user (such as font type or font size of the content, and page borders of the web content portion). The format of a particular web content portion of the web content portions is compared against (or with) a specified format. In some examples, the specified format can be based on previously reviewed content portions. In some examples, the specified format can be based on a template that is associated with a web content approver. When there is a difference between the format of the particular web content portion and the specified format, a message can be displayed (e.g., on a graphical user interface (GUI) used to create/edit the particular web content portion) indicating the difference.

A general embodiment of the subject matter described in this disclosure can be implemented in methods that include identifying web content including web content portions, wherein a particular web content portion includes a content and a format; comparing the format of the particular web content portion against a specified format; and based on the comparison including a difference between the format of the particular web content portion and the specified format, displaying a message indicating the difference between the format of the particular web content portion and the specified format.

Other general embodiments include corresponding computer systems, apparatus, and computer programs recorded on one or more computer storage devices, each configured to perform the actions of the methods. A system of one or more computers can be configured to perform operations to perform the actions. One or more computer programs can be configured to perform particular operations or actions by virtue of including instructions that, when executed by data processing apparatus, cause the apparatus to perform the actions.

A first aspect combinable with any of the general embodiments includes receiving an initiation of publication of the web content in a web portal; and based on the received initiation, initiating the comparison of the format of the web content portion against the specified format.

A second aspect combinable with any of the previous aspects, the format includes a layout of the web content portion defining at least one of page borders, font type, or font size.

A third aspect combinable with any of the previous aspects further includes identifying a revised web content portion including the content of the particular web content portion and a revised format.

A fourth aspect combinable with any of the previous aspects further includes comparing the revised format of the revised web content portion against the specified format.

A fifth aspect combinable with any of the previous aspects further includes based on the comparison including a substantial match between the revised format of the revised web content portion and the specified format, preparing the web content for publication.

A sixth aspect combinable with any of the previous aspects further includes determining a difference between the format of the particular web content portion and the revised format of the revised web content portion, the difference including a change to the format of the particular web content portion.

A seventh aspect combinable with any of the previous aspects further includes storing the change in a repository.

An eight aspect combinable with any of the previous aspects, the stored change is one of multiple changes stored in the repository.

A ninth aspect combinable with any of the previous aspects further includes matching the stored change with at least one of the changes stored in the repository.

A tenth aspect combinable with any of the previous aspects further includes determining a proposed correction based on the matched change.

An eleventh aspect combinable with any of the previous aspects further includes preparing a message that includes the proposed correction to send to a user.

A twelfth aspect combinable with any of the previous aspects wherein comparing the format of the particular web content portion against a specified format includes identifying a template based on a type of the web content.

A thirteenth aspect combinable with any of the previous aspects further includes comparing the format of the particular web content portion with the identified template.

A fourteenth aspect combinable with any of the previous aspects further includes based on the comparison including a difference between the format of the particular web content portion and the identified template, updating a report including the difference between the format of the particular web content portion and the identified template.

A fifteenth aspect combinable with any of the previous aspects further includes the template including an XML document.

A sixteenth aspect combinable with any of the previous aspects further includes identifying a revised web content portion including the content of the particular web content portion and a revised format.

A seventeenth aspect combinable with any of the previous aspects further includes comparing the revised format of the revised web content portion against the identified template.

An eighteenth aspect combinable with any of the previous aspects further includes based on the comparison including a substantial match between the revised format of the revised web content portion and the identified template, preparing the web content for approval.

A nineteenth aspect combinable with any of the previous aspects further includes receiving an indication of at least one approver for the web content.

A twentieth aspect combinable with any of the previous aspects further includes based on the at least one approver, identifying the template.

A twenty-first aspect combinable with any of the previous aspects further includes the identified template being one of a multiple identified templates, and each of the identified templates including a creation date.

A twenty-second aspect combinable with any of the previous aspects further includes comparing the creation dates of the identified templates to determine a most recent identified template.

A twenty-third aspect combinable with any of the previous aspects further includes comparing the revised format of the revised web content portion against the most recent identified template.

Various embodiments of a web content validation module according to the present disclosure may have one or more of the following features. For example, web content can be validated prior to sending to an approver for approval, thus, speeding up publication of the web content. Additionally, facilitation of enforcement of different standards and compliancy policies on the content published by different units in an organization can be achieved. Furthermore, standardization and prevention of reviews of “invalid” content can be minimized.

These general and specific aspects may be implemented using a device, system or method, or any combinations of devices, systems, or methods. For example, a system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions. The details of one or more implementations are set forth in the accompanying drawings and the description below. Other features, objects, and advantages will be apparent from the description and drawings, and from the claims.

### DESCRIPTION OF DRAWINGS

FIG. 1 illustrates an example distributed computing system operable to validate web content to be delivered through a web portal;

FIG. 2 illustrates an example architecture of a distributed computing system operable to validate web content to be delivered through a web portal;

FIG. 3 illustrates an example GUI for configuring the approvers of the web content;

FIG. 4 illustrates an example GUI for indicating approval and/or publication of the web content;

FIGS. 5A-5D illustrate example methods for validating web content to be delivered through a web portal; and

FIG. 6 illustrates an example XML document representing an example format of web content.

### DETAILED DESCRIPTION

This specification describes systems, methods, apparatus, and computer-readable media for validating web content provided to users. In some embodiments, to validate the web content, the web content is initially identified. The identified web content can include web content portions. In some examples, the web content portions include (e.g., are associated with) a content and a format. In some examples, the format describes how the content is visually presented to the user (such as font type or font size of the content, and page borders of the web content portion). The format of a particular web content portion of the web content portions is compared against (or with) a specified format. In some examples, the specified format can be based on previously reviewed content portions. In some examples, the specified format can be based on a template that is associated with a web content approver. When there is a difference between the format of the particular web content portion and the specified format, a message can be displayed (e.g., on a graphical user interface (GUI) used to create/edit the particular web content portion) indicating the difference.

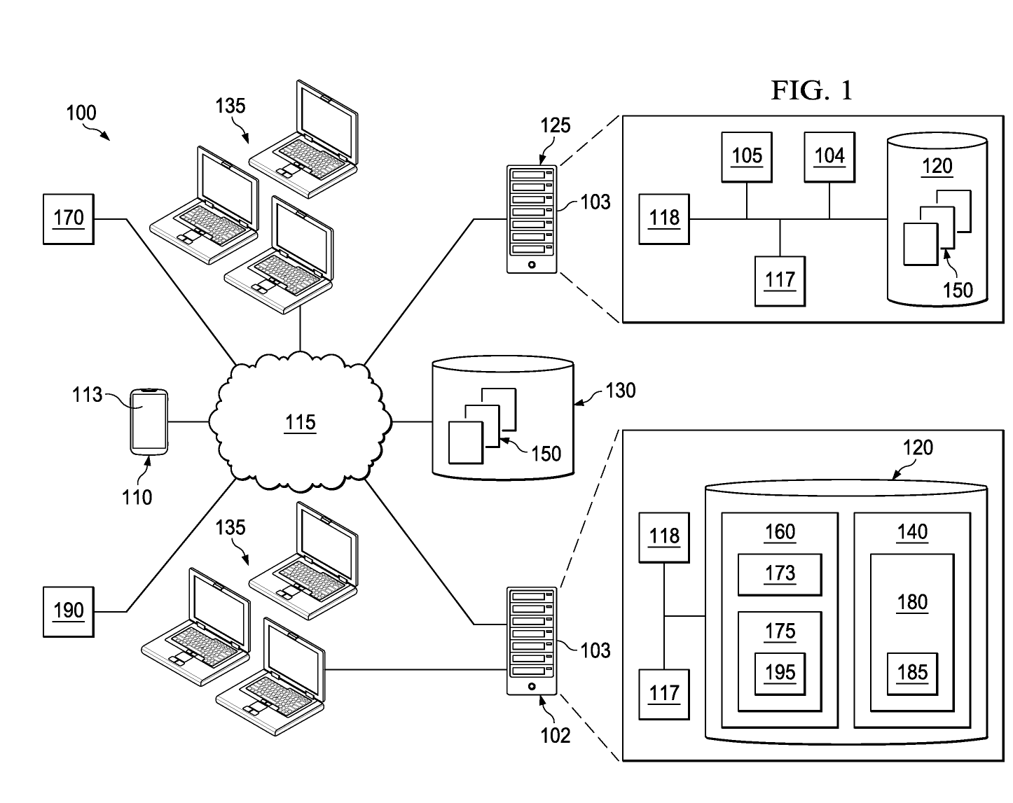

FIG. 1 illustrates an example distributed computing system 100 operable to validate web content. For example, the illustrated environment 100 includes or is communicably coupled with an enterprise computing system 102, a mobile communications device 110 (“mobile device”), a software provider computing system 125, a repository 130, one or more client computing devices 135 (“clients”), and a third party content provider 170, at least some of which communicate across a network 115.

The illustrated enterprise computing system 102 and the illustrated software provider computing system 125 both include separate servers 103. In general, each server 103 stores one or more hosted applications, such as, for example, a web content validation module 104 or a web content composer module 105, where at least a portion of the hosted applications are executed via requests and responses sent to users or clients within and communicably coupled to the illustrated environment 100 of FIG. 1. In some instances, the server 103 may store multiple various hosted applications, while in other instances, the server 103 may be a dedicated server meant to store and execute only a single hosted application (e.g., the web content validation module 104). In some instances, the server 103 may include a web server, where the hosted applications represent one or more web-based applications accessed and executed via network by the mobile device 110, the clients 135, or both to perform the programmed tasks or operations of the hosted application.

At a high level, each illustrated server 103 includes an electronic computing device operable to receive, transmit, process, store, or manage data and information associated with the environment 100. For example, one or both of the servers 103 illustrated in FIG. 1 may be responsible for receiving application requests from one or more client applications associated with the mobile device 110, the clients 135 or both of the environment 100 and responding to the received requests by processing said requests in an associated hosted application, and sending the appropriate response from the hosted application back to the requesting client application. In addition to requests from the mobile device 110, the clients 135 or both illustrated in FIG. 1, requests associated with the hosted applications may also be sent from internal users, external or third-party customers, other automated applications, as well as any other appropriate entities, individuals, systems, or computers.

As used in the present disclosure, the term “computer” is intended to encompass any suitable processing device. For example, although FIG. 1 illustrates single servers 103 for each of the enterprise computing system 102 and software developer computing system 125, environment 100 can be implemented using two or more servers 103 for each computing system (102 and 125), as well as computers other than servers, including a server pool. Indeed, server 103 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated server 103 may be adapted to execute any operating system, including Linux, UNIX, Windows, Mac OS, or any other suitable operating system.

The server 103 of software provider computing system 125 includes a web content validation module 104. The web content validation module 104 validates web content portions such that only validated web content portions are presented to an approver 190 for approval and/or is presented to users via clients 135 and/or the mobile device 110 (e.g., via the GUI 113). The web content portions can be validated based on comparing a format of the web content portion to a specified format. When a substantial match between a format of the web content portion and the specified format is determined, the web content portion can be presented to the approver 190 for approval. When a difference exists between the format of the web content portion and the specified format is determined, the format of the web content portion can be revised such that a match exists between the format of the revised web content portions and the specified format. The specified format can be based on previously reviewed web content portions and/or a template of the approver. The web content validation module 104 can be implemented by and stored by any combination of the enterprise computing system 102, the software providing computer system 125, the repository 130, the clients 135, and the mobile device 110.

The server 103 of the software provider computing system 125 includes a web content composer 105. The web content composer 105 composes and/or edits the web content portions that are to be validated by the web content validation module 104. In some examples, the web content composer 105 is a “what you see is what you get” (WYSIWYG) web content editor (such as HTML, XML, CSS, or Javascript).

Each of the illustrated servers 103 also includes an interface 117, a processor 118, and a memory 120. The interface 117 is used by the server 103 for communicating with other systems in a distributed environment—including within the environment 100—connected to the network 115; for example, the clients 135, the mobile device 110, or both, as well as other systems communicably coupled to the network 115. Generally, each interface 117 includes logic encoded in software and/or hardware in a suitable combination and operable to communicate with the network 115. More specifically, each interface 117 may include software supporting one or more communication protocols associated with communications such that the network 115 or interface's hardware is operable to communicate physical signals within and outside of the illustrated environment 100.

As illustrated in FIG. 1, each of the servers 103 includes a processor 118. Although illustrated as a single processor 118 in FIG. 1, two or more processors may be used according to particular needs, desires, or particular embodiments of the environment 100. Each processor 118 may be a central processing unit (CPU), a blade, an application specific integrated circuit (ASIC), a field-programmable gate array (FPGA), or another suitable component. Generally, the processor 118 executes instructions and manipulates data to perform the operations of the server 103. For example, the processor 118 executes the functionality required to receive and respond to requests from the clients 135 and/or the mobile device 110.

Regardless of the particular implementation, “software” may include computer-readable instructions, firmware, wired or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java, Visual Basic, assembler, Perl, any suitable version of 4GL, as well as others. While portions of the software illustrated in FIG. 1 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate.

Each of the servers 103 also includes a memory 120, or multiple memories 120. The memory 120 may include any memory or database module and may take the form of volatile or non-volatile memory including, without limitation, magnetic media, optical media, random access memory (RAM), read-only memory (ROM), removable media, or any other suitable local or remote memory component. The memory 120 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the computing system 102, 125. Additionally, the memory 120 may include any other appropriate data, such as VPN applications, firmware logs and policies, firewall policies, a security or access log, print or other reporting files, as well as others.

The environment further includes an illustrated repository 130. In some embodiments, the repository 130 is an in-memory repository. The repository 130 can be a cloud-based storage medium. For example, the repository 130 can be networked online storage where data is stored on virtualized pools of storage.

The illustrated environment of FIG. 1 also includes one or more clients 135 and the mobile device 110, or multiple mobile devices 110. Each client 135 and/or the mobile device 110 may be any computing device operable to connect to or communicate with at least the computing systems 102, 125 and/or via the network 115 using a wireline or wireless connection. In general, each client 135 and/or the mobile device 110 includes an electronic computer device operable to receive, transmit, process, and store any appropriate data associated with the environment 100 of FIG. 1.

There may be any number of clients 135 and/or mobile devices 110 associated with, or external to, the environment 100. For example, while the illustrated environment 100 includes six clients 135 and one mobile device 110, alternative implementations of environment 100 may include a single client 135 or multiple mobile devices 110 communicably coupled to the server 102 and/or the network 115, or any other number suitable to the purposes of the environment 100.

Additionally, there may also be one or more additional clients 135 and/or mobile devices 110 external to the illustrated portion of environment 100 that are capable of interacting with the environment 100 via the network 115. Further, the term “client” and “user” may be used interchangeably as appropriate without departing from the scope of this disclosure. Moreover, while each client 135 and/or the mobile device 110 is described in terms of being used by a single user, this disclosure contemplates that many users may use one computer, or that one user may use multiple computers. As used in this disclosure, the client 135 is intended to encompass a personal computer, tablet computer, smart phone, cell phone, personal digital assistant (PDA), touch screen terminal, workstation, network computer, kiosk, one or more processors within these or other devices, or any other suitable processing device.

The illustrated mobile device 110 may be any mobile computing device such as a wireless data port, smart phone, personal data assistant (PDA), tablet computing device, one or more processors within these devices, or any other suitable processing device. For example, each client 135 and the mobile device 110 may include a computer that includes an input device, such as a keypad, touch screen, mouse (in the client 135 example), or other device that can accept user information, and an output device that conveys information associated with the operation of the computing systems 102, 125 or the client 135 or the mobile device 100 itself, including digital data, visual information, or a graphic user interface (GUI) 113, as shown with respect to the mobile device 110. In the example of the clients 135, both the input and output device may include fixed or removable storage media such as a magnetic storage media, CD-ROM, or other suitable media to both receive input from and provide output to users of the clients 135 through the display.

Further, the mobile device 110 includes the GUI 113 to interface with at least a portion of the environment 100 for any suitable purpose, including generating a visual representation of a web browser. Generally, through the GUI 113, the user is provided with an efficient and user-friendly presentation of data provided by or communicated within the system. The term “graphical user interface,” or GUI, may be used in the singular or the plural to describe one or more graphical user interfaces and each of the displays of a particular graphical user interface. Therefore, the GUI 113 can represent any graphical user interface, including but not limited to, a web browser, touch screen, or command line interface (CLI) that processes information in the environment 100 and efficiently presents the information results to the user. In general, the GUI 113 may include multiple user interface (UI) elements, some or all associated with a web browser, such as interactive fields, pull-down lists, and buttons operable by the user at the mobile device 113. These and other UI elements may be related to or represent the functions of the web browser. In particular, the GUI 113 may be used to view and navigate various web pages located both internal and external to the server.

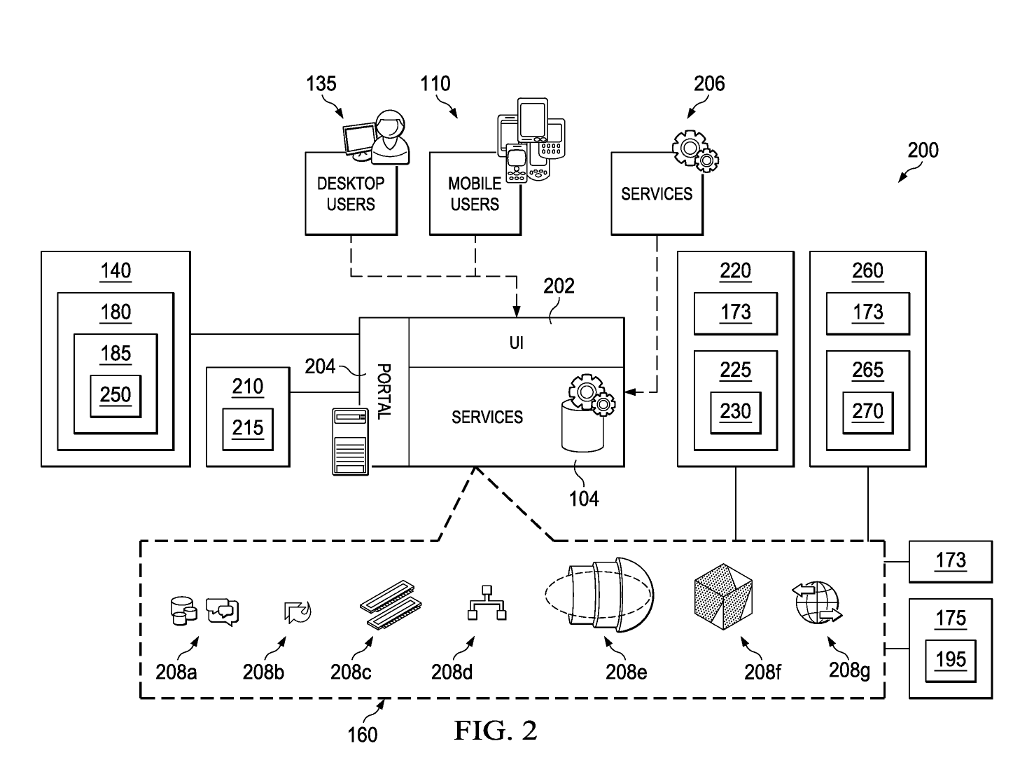

In some embodiments, one or more of the mobile device 110 (or mobile devices 110) and clients 135 may access one or more applications hosted on the software developer computing system 125 through a portal such as an enterprise portal, also known as an enterprise information portal (EIP) or corporate portal. The web portal (e.g., portal 204 illustrated in FIG. 2) may be a framework for integrating information, people and processes across organizational boundaries. It provides a secure unified access point, often in the form of a web-based user interface, and is designed to aggregate and personalize information through application-specific portlets. For example, the web portal may exhibit de-centralized content contribution and content management, which keeps the information always updated. With only a web browser, users can begin work once they have been authenticated in the portal which offers a single point of access to information, enterprise applications, and services both inside and outside an organization. Enterprise portals may present information from diverse sources in a unified way, and provide additional services, such as an internal search engine, e-mail, news, and various other features. Enterprise portals are often used by enterprises for providing their employees, customers, and possibly additional users with a consistent look and feel, and access control and procedures for multiple applications, which otherwise would have been separate entities altogether

The environment 100 further includes user data 140, web content 150, and web content portions 160. In the illustrated embodiment, the user data 140 is stored by the memory 120 of the enterprise computing system 102. However, the user data 140 can be stored in any combination of the memory of the mobile device 110, the enterprise computing system 102, the software provider service computing system 125, the repository 130, and/or the clients 135. In some implementations, the user data 140 is stored by a third party that provides networked online storage. In some embodiments, the user data 140 can include user profiles 180 of users of the clients 135 and the mobile device 110. In some embodiments, the user data 140 can include user profiles 180 of the approvers 190 of the web content portions 160, described further below. The user profiles 180 can further be associated with (e.g., included) templates 185. In some examples, each of the user profiles 180 can be associated with differing templates 185. The templates 185 serve as a comparison tool for approving of the web content portions 160, described further below.

The illustrated web content 150 is the textual, visual or aural content that is encountered as part of the user experience on websites. The web content 150 may include, among other things: text, images, sounds, videos, applications, sub-applications, and animations. The web content is stored by any combination of the software provider service computing system 125 and the repository 130.

In some embodiments, the illustrated web content portions 160 are sub-portions of the web content 150. The web content portions 160 are any kind of application, information, or service that can be visualized in a Web browser frame. The web content portions 160, in some embodiments, may be self-contained Web documents that are provided via a Uniform Resource Locator (URL) that are managed by the enterprise computing system 102. For example, the web content portions 160 can include alerts, reports, emails, calendars, text documents, multimedia files, reports, files, applications, and other content. For example, if a user enters a word in a dictionary web content portion 160, the definition appears inside the area of the web content portions 160. A link to usage examples, similar words, etc. can also be provided.

In some embodiments, the web content portions 160 include a content 173 and a format 175. The content 173 of the web content portions 160 is the substance of the web content portions 160 (e.g., the information and/or experiences that can provide value to the user in specific contexts). The format 175 describes a layout of the web content portions 160. For examples, the format 175 describes how the content 173 of the web content portions 160 is published and provided to the users via a GUI of the clients 135 and/or the mobile device 110. The format 175 can include text formatting (e.g., text size, text font, text color, text highlighting, text shading); and border formatting (e.g., border size, border position).

The web content portions 160 can include one or more of the characteristics of: stateless (not permanently connected to any component of the environment 100); embedded (non-dominant, parallel to other web content portions 160); provide previews on underlying processes and/or data; one-screen interactions; include only key functionality; provide direct access without navigation; push information and refresh periodically; integration with third-party software; and allow users to modify an appearance thereof. The web content portions 160 may provide data, for example, providing active information; monitor business processes; preview data and processes; display notifications for starting task-related processes; and offering access to often used data. The web content portions 160 may further provide direct access to simple applications; accelerated access to other applications; reduction of information and interaction to the necessary; and drag-and-relate that use outputs as inputs within the environment 100. The web content portions 160 offer customization such that specific web content portions 160, along with reduction of information and tailoring of information presented by the web content portions 160, can be implemented according to the user data 140.

As illustrated, the web content portions 160 are stored by the memory 120 of the enterprise computing system 102. However, the web content portions 160 can be stored in any combination of the memory the enterprise computing system 102, the software provider service computing system 125, and/or the repository 130. In some embodiments, the web content portions 160 can be provided by and stored by the third party content provider 170.

The approver 190 can approve the web content portions 160 for publication within a portal environment. In some examples, approval of the web content portions 160 can include display (e.g., publication) of the web content portions 160 via a GUI of the clients 135 and/or the mobile device (e.g., the GUI 113 of the mobile device 110) to other users (e.g., users other than the creator/editor of the web content portions 160). The approver 190 can be a person, a computer-implemented software module, or a combination of both.

FIG. 2 illustrates an example environment 200 of a distributed computing system operable to suggest contextually-relevant content objects. The environment 200 includes the clients 135, the mobile device 110, the web content verification module 104, a graphical user interface (GUI) 202, a portal 204, services 206, content sources 208a-208g, the web content portions 160, the user data 140 that includes the user profiles 180, and a specified format 210. The web content portions 160 include the content 173 and the format 175 and the user profiles 180 are associated with the templates 185.

The web content portions 160 that are accessed by users of the clients 135, users of the mobile device 110, or users of both (“users”), are identified. The users access the web content portions 160 through interaction with the GUI 202. The web content portions 160 can be stored by, and retrieved from, the one or more content sources 208a-208g.

In the illustrated embodiment, the services 206 may facilitate communication between the web content validation module 104 and one or more clients 135 and/or the mobile device 110 outside of the GUI 202. Accordingly, the clients 135 and the mobile device 110 may implement the functionality of the web content validation module 104 without accessing the GUI 202 (i.e., without a UI layer), such as, for example, through a query.

Content source 208a, for instance, may include a collaboration module that stores, references, and/or accumulates content for sharing and other collaborative actions across multiple systems and/or user (such as across a business enterprise). For example, a collaborative environment or collaboration module in an enterprise environment may share and accumulate information (i.e., content) that enables users to share content and work together in mutual areas in the portal.

Content source 208b, for instance, may include an enterprise resource system (ERP) associated with the software developer computing system 125 that integrates internal and external business and management information across a business enterprise (e.g., finance/accounting, manufacturing, sales and service, and customer relationship management streams of data). The ERP system may facilitate the flow of information between all business functions inside the boundaries of the organization and manage the connections to outside customers and/or clients. The ERP system may include a client/server architecture with one or more databases with modifiable software executing thereon to provide an end-to-end business solution.

Content source 208c, for instance, may include content stored, referenced, and/or calculated on an in-memory database associated with the software developer computing system 125. The in-memory database may include integrated processing, i.e., all business and/or analytic operations done in processing memory. Moreover, content from business content sources may be replicated from one or more transactional systems (e.g., coupled to the network 115) to the in-memory database immediately. Thus, the in-memory database, in some aspects, may handle the analytical systems for all business data in real-time, as opposed to, for instance, computational processing systems that have separate transactional and analytical systems that connect through relational databases (i.e., relational databases stored on magnetic memory that require a process, e.g., ETL, to transfer data from one system to another not in real time but with a delay of an hour, day, week, or longer). In some embodiments, the in-memory database may expose business data and capabilities to improve an end-solution for end users (e.g., the clients 135). The in-memory database may reside on top of a computational engine that facilitates fast manipulations on large amounts of business data and/or replication of entire business suite information. Thus, in some embodiments, the in-memory database may provide for the following design principles/concepts: business data in real-time (e.g., GUI patterns for constantly updated business data); well modeled tables and data cubes (e.g., in order to provide semantic services); a highly parallelized computational engine (e.g., for computationally intensive GUI patterns such as real time alerts and/or suggestions); close coupling of business logic and business data (e.g., eliminating indexing and caching).

Content source 208d, for instance, may include a gateway technology associated with the software developer computing system 125 that provides a simple way to connect devices, environments and platforms based on market standards. For example, the gateway may, for example, be a front-end server to a business suite application and expose business suite services in an open protocol format. Exposed content may include, business and/or social data through social updates, for example, Twitter, Facebook, RSS feed/channels, and/or other feed sources or channels.

Content source 208e, for instance, may include a business object repository. Each business object stored in the repository, for example, may include a capsule with an internal hierarchical structure, behavior offered by its operations, and integrity constraints. In general, the overall structure of the business object model ensures the consistency of the interfaces that are derived from the business object model. The derivation helps ensure that the same business-related subject matter or concept can be represented and structured in the same way in various interfaces. The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Business objects are generally semantically disjointed, i.e., the same business information is represented once. In some embodiments, the business objects are arranged in an ordering framework such that they can be arranged according to their existence dependency to each other. For example, in a modeling environment, the customizing elements might be arranged on the left side of the business object model, the strategic elements might be arranged in the center of the business object model, and the operative elements might be arranged on the right side of the business object model. Similarly, the business objects can be arranged in this model from the top to the bottom based on defined order of the business areas, e.g., finance could be arranged at the top of the business object model with customer relationship management (CRM) below finance and supplier relationship management (SRM) below CRM. To help ensure the consistency of interfaces, the business object model may be built using standardized data types as well as packages to group related elements together, and package templates and entity templates to specify the arrangement of packages and entities within the structure.

A business object may be defined such that it contains multiple layers. Typical business object may contains four layers: a kernel layer, an integrity layer, an interface layer, and an access layer. The innermost layer of the example business object is the kernel layer. The kernel layer represents the business object's inherent data, containing various attributes of the defined business object. The second layer represents the integrity layer. The integrity layer contains the business logic of the object. Such logic may include business rules for consistent embedding in a computing environment and the constraints regarding the values and domains that apply to the business object. Business logic may include statements that define or constrain some aspect of the business, such that they are intended to assert business structure or to control or influence the behavior of the business entity. It may pertain to the facts recorded on data and constraints on changes to that data. In effect, business logic may determine what data may, or may not, be recorded in business object. The third layer, the interface layer, may supply the valid options for accessing the business object and describe the implementation, structure, and interface of the business object to the outside world. To do so, the interface layer may contain methods, input event controls, and output events. The fourth and outermost layer of the business object is the access layer. The access layer defines the technologies that may be used for external access to the business object's data. Some examples of allowed technologies may include COM/DCOM (Component Object Model/Distributed Component Object Model), CORBA (Common Object Request Broker Architecture), RFC (Remote Function Call), Hypertext Transfer Protocol (HTTP) and Java, among others. Additionally, business objects of this embodiment may implement standard object-oriented technologies such as encapsulation, inheritance, and/or polymorphism.

Content source 408f, for instance, may include, a business intelligence module that, at a high level, provides software and/or middleware services for performance analytics (e.g., supports organizational efforts to develop sophisticated visual representations of processes and performance, providing organizations with new insights that can help them make more informed decisions, assess and plan a business intelligence strategy, deploy dashboard tools, generate management and operational reports, and build an IT infrastructure that provides high scalability for users and data); services for analytic applications (e.g., provides guidance and deployment expertise in implementing analytic applications, offering pre-built analytics and data models to help a customer with a specific business problem in various industries, helping organizations to efficiently deploy applications); and introductory business intelligence services (e.g., introduces organizations to the dynamics of using business intelligence, providing the ability to leverage the functionality of business intelligence—such as executive dashboards and operational reports—without initiating a full-scale implementation).

Content source 208f, for instance, may be content from third party platforms, such as content from third parties unaffiliated with, for example, the software developer computing system 125 and enterprise computing system 102. For instance, content source 208f may be content from third party content provider 170.

To that end, in some examples, the web content portions 160 can be validated (e.g., approved for presentation/publication) within the portal 204. Specifically, to validate the web content portions 160, the web content 150 is initially identified. The web content 150 includes the web content portions 160. In some examples, the web content portions 160 include (e.g., are associated with) a content 173 and a format 175. The format 175 of a particular web content portion 160 is compared against (or with) the specified format 210. In some examples, the specified format 210 can be based on previously reviewed (and approved) web content portions 160. In some examples, the specified format 210 can be based on one or more of the templates 185 associated with one or more of the approvers 190. When there is a difference between the format 175 of the particular web content portion 160 and the specified format 210, a message can be displayed (e.g., on a graphical user interface (GUI) used to create/edit the particular web content portion 160) indicating the difference.

Specifically, the web content 150 is identified that includes the web content portions 160. The web content portions 160 can be created and/or edited by the users of the clients 135, the mobile device 110, or both. As mentioned above, the web content portions 160 can include (be associated with) a content 173 and a format 175. The content 173 includes the “substance” of the web content portions 160 and the format 175 describes the layout of the web content portions 160. For example, the format 175 describes how the content 173 is visually presented to the user (such as font type or font size of the content, and page borders of the web content portion 160). In some examples, each of the web content portions 160 can have a differing format 175. In some examples, one or more of the web content portions 160 can have a same format 175. In some examples, the format 175 of the web content portions 160 is based on (or dependent on) the substance (e.g., the content 173) of the web content portions 160. In some examples, attributes 195 of the format 175 (e.g., the font type, font size, page borders) can differ for each associated web content portion 160. In some examples, the attributes 195 of the format 175 are based on (or dependent on) the substance (e.g., the content 173) of the web content portions 160. In some embodiments, the portal 204, the web content validation module 104, or both, identify the web content 150 that includes the web content portions 160.

The format 175 of a particular web content portion 160 of the web content 150 is compared against (or compared with) the specified format 210. In some examples, comparing of the format 175 of particular web content portion 160 against the specified format 210 can include comparing one or more attributes 195 of the format 175 of the particular web content portion 160 to one or more corresponding attributes 215 of the specified format 210. In some examples, comparing the format 175 of the particular web content portion 160 against the specified format 210 can include identifying differences, similarities (including exact matches), or both, between the attributes 195 of the format 175 and the corresponding attributes 215 of the specified format 210. In some embodiments, the portal 204, the web content validation module 104, or both, compare the format 175 of the particular web content portion 160 against the specified format 210.

In some examples, an initiation is received for publication of the particular web content 160 in the web portal 204, and based on the (received) initiation, the comparison of the particular web content portion 160 against (or compared with) the specified format 210 is initiated. For example, the user that creates/edits the particular web content portion 160 can provide the initiation by clicking a “publish” button on a GUI of the clients 135 and/or the mobile device 110 (described further below), sending the particular web content portion 160 to the web content validation module 104 for comparison of the particular web content portion 160 against the specified format 210. In some examples, the particular web content portion 160 can be scheduled for automatic publishing according a schedule.

In some examples, comparing the format 175 of the particular web content portion 160 against the specified format 210 can further include providing a matching value between the format 175 and the specified format 210, and further, a matching value between each of the attributes 195 of the format 175 and the corresponding attributes 215 of the specified format 210. When a matching value between an attribute 175 and a corresponding attribute 215 is above (or equal to) a matching threshold, the attribute 175 and the corresponding attribute 215 are deemed to be matched. When the matching value between an attribute 175 and a corresponding attribute 215 is below the matching threshold, the attribute 175 and the corresponding attribute 215 are not deemed to be matched (or, in some embodiments, deemed to be not matched). When the attribute 175 and the corresponding attribute 215 are not deemed to be matched, a difference exists between the format 175 and the specified format 210. In some examples, the matching threshold is a minimum level of matching or “closeness” between the attributes 195 and the corresponding attributes 215 for the attributes 195 and the corresponding attributes 215 to be considered matching.

In some examples, the matching of the format 175 and the specified format 210 is based on the matching of the attributes 195 and the corresponding attributes 215. For example, when a number of attributes 195 and corresponding attributes 215 that are deemed to match is above (or equal to) a threshold number, the format 175 and the specified format 215 are deemed to match. When a number of attributes 195 and the corresponding attributes 215 that are deemed to match is below the threshold number, the format 175 and the specified format 210 are not deemed to match (or in some embodiments, deemed to be not matched).

Based on the aforementioned comparison between the format 175 of the particular web content portion 160 and the specified format 210 including a difference, a message is displayed indicating the difference between the format 175 of the particular web content portion 160 and the specified format 210. In some examples, the difference between the format 175 and the specified format 210 can include differences between the attributes 195 associated with the format 175 and corresponding attributes 215 associated with the specified format 210. For example, when a matching value between one or more attributes 195 and one or more corresponding attributes 215 is less than a matching value, a difference exists between the format 175 and the specified format 210. In some embodiments, the portal 204, the web content validation module, or both, display the message indicating the difference between the format 175 and the specified format 210.

In some examples, the message can indicate two or more differences between the format 175 of the particular web content portion 160 and the specified format 210. In some examples, the message can indicate details of the difference (e.g., a location of the difference, how to “fix” the difference). In some examples, the message is displayed by the clients 135 and/or the mobile device 110 via a GUI (e.g., the GUI 113 of the mobile device 110). In some examples, the message can be displayed via a pop up display, a notification with an application working environment, or other such notification means.

In some additional embodiments, the particular web content portion 160 can be revised to define a revised web content portion 220 (e.g., revised by the user that created the web content portion 160). The revised web content portion 220 can then be identified. The revised web content portion 220 includes (or is associated with) the content 173 of the particular web content portion 160 and a revised format 225. The revised format 225 can include (or be associated with) attributes 230 that are based on the attributes 195 of the format 175. For example, the user can revise the attributes 195 of the particular web content portion 160 to define the attributes 230 of the revised web content portions 220. The user can revise the attributes 195 (to define the attributes 230) by adjusting (or changing) the attributes 195, such as changing the font size, the font type, or the page border.

Similar to that mentioned above, the revised format 225 of the revised web content portion 220 can be compared against (or with) the specified format 210. In some examples, comparing of the revised format 225 of the revised web content portion 220 against the specified format 210 can include comparing one or more attributes 230 of the revised format 225 to one or more corresponding attributes 215 of the specified format 210. In some examples, comparing the revised format 225 of the revised web content portion 220 against the specified format 210 can include identifying differences, similarities (including exact matches), or both, between attributes 230 of the revised format 225 and corresponding attributes 215 of the specified format 210. In some embodiments, the portal 204, the web content validation module 104, or both, compares the revised format 225 of the revised web content portion 220 against the specified format 210.

Similar to that mentioned above, based on the comparison between the revised format 225 of the revised web content portion 220 and the specified format 210 including a substantial match, the revised web content portion 220 is prepared for publication. In some examples, the matching between the revised format 225 and the specified format 210 can include matching between the attributes 230 associated with the revised format 225 and the corresponding attributes 215 associated with the specified format 210. For example, when a matching value between each of the attributes 230 and the corresponding attributes 215 is greater than a matching value, a substantial match exists between the revised format 225 and the specified format 210. In some examples, preparing for publication of the revised web content portion 220 can include sending the revised web content portion 220 to a publication module (not shown) for publication of the revised web content portion 220; displaying the revised web content portion 220 on a GUI of the clients 135, the mobile device 110, or both; providing the revised web content portion 220 to other users; or a combination thereof.

In some additional embodiments, a difference is determined between the format 175 of the particular web content portion 160 and the revised format 225 of the revised web content portion 220. The difference includes a change to the format 175 of the particular web content portion 160. In some examples, the change to the format 175 is based on a change to the attributes 195 associated with the format 175 to define the attributes 230 associated with the revised format 225. In some examples, the change can include a change to the text size of the content 173, a change to the text font of the content 173, a change to the page borders (e.g., a size and shape of the page borders), adding a web snippet (e.g., header, footer, image) to the content 173, or a combination thereof. In some examples, the difference can include two or more changes to the format 175 of the particular web content portion 160. The change can be stored in a repository (e.g., the repository 130, the memory of the computing system 102 and 125, or a combination thereof). In some embodiments, the portal 204, the web content validation engine 104, or both, determine the difference between the format 175 and the revised format 225.

As mentioned above, in some embodiments, the specified format 210 can be based on previous actions of the user (e.g., previously reviewed (and approved) web content portions 160 submitted by the user) such that the web content validation module 104 “learns” from the previous actions of the user. In summary, the web content validation module 104 can identify common “faults” (e.g., the differences between the format 175 of the particular content portion 160 and the specified format 210) in the web content portions 160 previously submitted to and reviewed by the web content validation module 104. The web content validation module 104 can then bring these “faults” to the attention of the user that created and/or edited the particular web content portion 160 based on a comparison of the format 175 of the particular web content portion 160 to the stored “faults.” By storing such “faults,” the web content validation module 104 can identify patterns that are specific to the user that submits the particular web content portion 160 for publication. In some examples, the patterns can relate to identifying the difference between the format 175 and the specified format 210 and determining the change to the format 175 such that the revised format 225 matches the specified format 210. In some examples, the patterns are a delta between the format 175 and the revised format 225 (e.g., the changes between the format 175 and the revised format 225).

Specifically, the aforementioned change to the format 175 (from the determined difference between the format 175 of the particular web content portion 160 and the revised format 225 of the revised web content portion 220) is one of multiple changes stored in the repository (e.g., the repository 130, the memory of the computing system 102 and 125, or a combination thereof). The multiple changes stored in the repository can be based on previously submitted web content portions 160 to the approver 190 and changes to the format 175 of the web content portions 160 such that the revised format 225 substantially matches the specified format 210. In some examples, the changes can be associated with a single user (e.g., the user creating and/or editing the particular web content portion 160) or can be associated with multiple users (e.g., users that interact with the portal 204).

The aforementioned stored change to the format 175 can be matched to one or more of the previous changes that are stored by the repository. For example, each of the stored changes are associated with the attributes 195. To that end, for each change to the format 175, a matching change to a similar (or identical) attribute stored by the repository is determined. A proposed correction can be determined based on matching the change to the format 175 to changes of similar (or identical attributes) stored by the repository. The proposed correction can be a change to one of the attributes 195 of the format 175 based on the determined change such that the revised format 225 matches the specified format 210. In some examples, the proposed correction can include two or more possible options for the change to one of the attributes 195 of the format 175 such that the revised format 225 matches the specified format 210. In some embodiments, the portal 204, the web content validation module 104, or both, matches the changes to the format 175 and the stored changes and determines the proposed correction.

A message is prepared that is based on the proposed correction and sent to the user (e.g., the user that created and/or edited the particular web content portion 160). In some examples, the message can include an activation option to active the proposed correction to the format 175. In some examples, the message is displayed by the clients 135 and/or the mobile device 110 via a GUI (e.g., the GUI 113 of the mobile device 110). In some examples, the message can be displayed via a pop up display, a notification with an application working environment, or other such notification means.

As mentioned above, in some embodiments, the specified format 210 can be based on the templates 185 associated with the approvers 190 (and that are further associated with the user profiles 180 of the approvers 190). In summary, each approver 190 can be associated with a differing template 185. The template 185 serves as a comparison tool for approving of the web content portions 160. To that end, the format 175 of the particular web content portion 160 can be compared to one or more templates 185. In some examples, the number of templates 185 employed in the comparison is based on a number of approvers 190 associated with the user providing the particular web content portion 160; a set number of approvers 190; based on the content of the particular web content portion 160; or a combination thereof. Based on the comparison of the format 175 to one or more templates 185, the user (e.g., the user creating or providing the particular web content object 160) can receive a report (e.g., via a GUI of the clients 135 and/or the mobile device 110) detailing any “validation errors.” The “validation errors” can include differences between the format 175 of the particular content portion 160 and the specified format 210. Thus, the user can respond to the “validation errors” by changing one or more attributes of the format 175 such that the revised format 225 substantially matches the specified format 210.

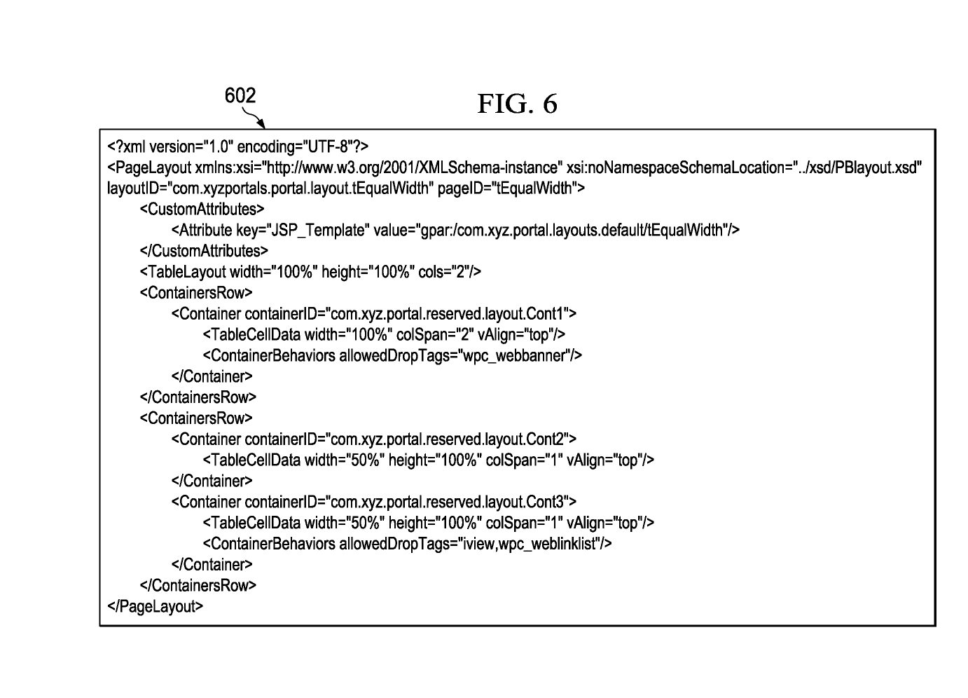

Specifically, a template 185 is identified based on a type of the particular web content portion 160 (e.g., the content 173, the format 175, or both, of the particular web content portion 160). The template 185 can include (or be associated with) attributes 250. The attributes 250 can be analogous to the attributes 195 of the format 175 or the attributes 215 of the particular format 210. In some examples, the template 185 includes an extensible markup language (XML) document. An examples XML document 602 representing an example format 175 (e.g., layout) is illustrated in FIG. 6. In some examples, the template 185 can be associated with a timestamp and/or a priority.

Similar to that mentioned above, the format 175 of the particular web content portion 160 can be compared against (or with) the template 185. In some examples, comparing of the format 175 of the particular web content portion 160 against (or with) the specified format 210 can include comparing one or more attributes 195 of the format 175 to one or more corresponding attributes 250 of the template 185. In some examples, comparing the format 175 against the template 185 can include identifying differences, similarities (including exact matches), or both, between attributes 195 of the format 175 and corresponding attributes 250 of the template 185. In some examples, the format 175 can be compared against (or with) two or more templates 185. In some embodiments, the portal 204, the web content validation module 104, or both, compare the format 175 of the particular web content portion 160 against the template 185.

In some examples, comparing the format 175 of particular web content portion 160 against the template 185 can further include providing a matching value between the format 175 and the template 185, and further, a matching value between the attributes 195 of the format 175 and the corresponding attributes 250 of the template 185. When a matching value between the attributes 195 and the corresponding attributes 250 is above (or equal to) a matching threshold, the attributes 195 and the corresponding attributes 250 are deemed to be matched. When the matching value between the attributes 195 and the corresponding attributes 250 is below the matching threshold, the attributes 195 and the corresponding attributes 250 are not deemed to be matched (or, in some embodiments, deemed to be not matched). When the attributes 195 and the corresponding attributes 250 are not deemed to be matched, a difference exists between the format 175 and the template 185. In some examples, the matching threshold is a minimum level of matching or “closeness” between the attributes 195 and the corresponding attributes 250 for the attributes 195 and the corresponding attributes 250 to be considered matching.

Similar to that mentioned above, based on the comparison between the format 175 of the particular web content portion 160 and the template 185 including a difference, a report is updated including the difference between the format 175 of the particular web content portion 160 and the template 185. In some examples, the report includes details of the template 185 employed in the comparison (e.g., HR template for corporate portal). In some examples, the difference between the format 175 and the template 185 can include differences between the attributes 195 associated with the format 175 and the corresponding attributes 250 associated with the template 185. For example, when a matching value between one or more attributes 195 and one or more corresponding attributes 250 is less than a matching value, a difference exists between the format 175 and the template 185. In some embodiments, the portal 204, the web content validation module 104, or both, updates the report including the differences between the format 175 and the template 185.

In some additional embodiments, the particular web content portion 160 can be revised to define a revised web content portion 260 (e.g., by the user that created the web content portion 160). The revised web content portion 260 can then be identified. The revised web content portion 260 includes (or is associated with) the content 173 of the particular web content portion 160 and a revised format 265. The revised format 265 can include (or be associated with) attributes 270 that are based on the attributes 250 of the template 185. For example, the user can revise the attributes 195 of the particular web content portion 160 to define the attributes 270 of the revised web content portion 260. The user can revise the attributes 195 (to define the attributes 270) by adjusting (or changing) the attributes 195, such as changing the font size, the font type, or the page border.

Similar to that mentioned above, the revised format 265 of the revised web content portion 260 can be compared against (or with) the template 185. In some examples, comparing of the revised format 265 of the revised web content portion 260 against the template 185 can include comparing one or more attributes 270 of the revised format 265 to one or more corresponding attributes 250 of the template 185. In some examples, comparing the revised format 265 of the revised web content portion 260 against the template 185 can include identifying differences, similarities (including exact matches), or both, between the attributes 270 of the revised format 265 and the corresponding attributes 250 of the template 185. In some embodiments, the portal 204, the web content validation module 104, or both, compare the revised format 265 of the revised web content portion 260 against the template 815.

Similar to that mentioned above, based on the comparison between the revised format 265 of the revised web content portion 260 and the template 185 including a substantial match, the revised web content portion 260 is prepared for approval and/or publication. In some examples, the matching between the revised format 265 and the template 185 can include matching between the attributes 270 associated with the revised format 265 and the corresponding attributes 250 associated with the template 185. For example, when a matching value between each of the attributes 270 and the corresponding attributes 250 is greater than a matching value, a substantial match exists between the revised format 265 and the template 185. In some examples, preparing for approval and/or publication of the revised web content portion 260 can include sending the revised web content portion 260 to the approver 190 (or approvers 190) associated with the template 185.

In some embodiments, an indication is received (e.g., by the portal 204 and/or the web content validation module 104) for at least one approver 190 for the particular web content 160. Based on the received indication, the template 185 that is associated with the approver 190 is identified. For example, when the user is creating and/or editing the particular web content portion 160, the user can receive an indication of the approver 190 and the associated template 185 of the approver 190 for which the particular web content 160 (and the format 175) will be compared against. In some examples, the portal 204, the web content validation module 104, or both, receives the indication and identifies the template 185.

In some examples, when the approver 190 is associated with two or more templates 185, the template 185 that is identified (and employed in comparison with the format of the web content portions) can be based on one or more properties associated with the templates 185. For example, as mentioned above, the template 185 can be associated with a timestamp (e.g., a creation date) and/or a priority. In some examples, the template 185 that is identified can be the template 185 with the highest priority. In some examples, the creation date of each template 185 can be compared to determine a most recent template 185 (e.g., the “newest” template 185). Thus, the revised format 265 of the revised web content portion 260 (or similarly, the format 175 of the particular web content portion 160) can be compared against the most recent template 185. In some examples, the portal 204, the web content validation module 104, or both, compares the creation dates of the templates 185.

In some examples, an indication is received for two or more approvers 190 for the particular web content 160. Thus, two or more templates 185 are identified for which the particular web content 160 (and the format 175) will be compared against. To that end, when two or more templates 185 are employed, a collision may occur when the format 175 is compared against the templates 185. In some examples, collisions can include different fonts, different footers, etc., of the two or more templates 185. To minimize, if not avoid collisions, rules may be applied to the order in which the two or more templates 185 are compared to the format 175. In some examples, the templates 185 can have an associated priority, and the template with the highest priority will be the last template 185 compared to the format 175 (e.g., the last template 185 will supersede previous comparisons of the format 175 with the lower priority templates 185).

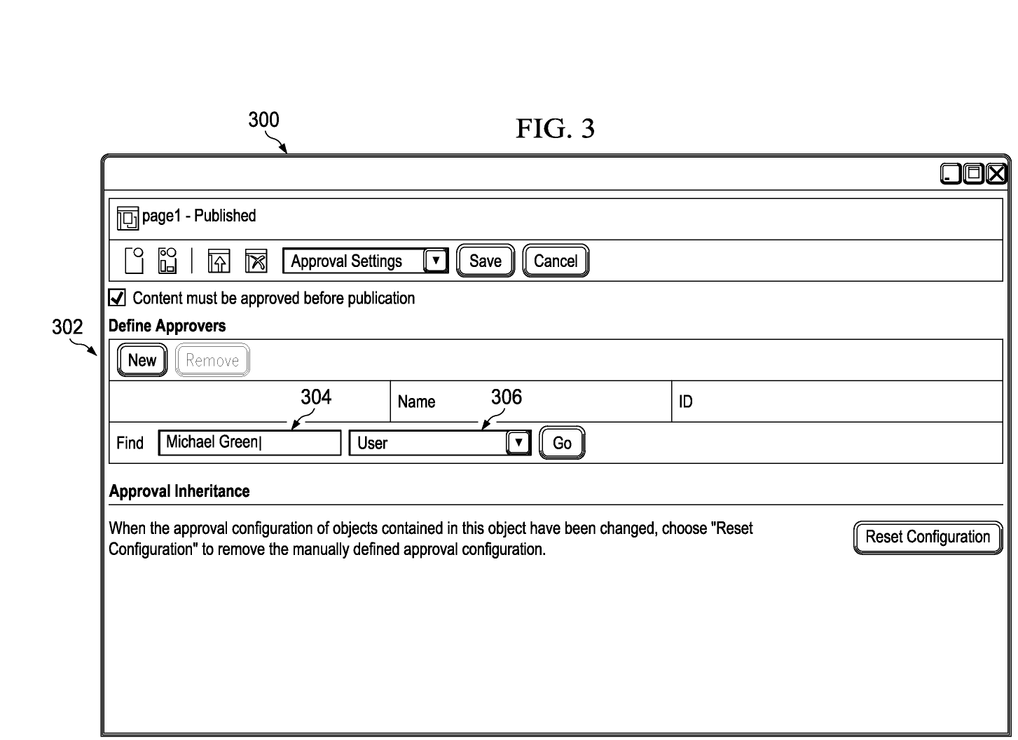

FIG. 3 illustrates an example GUI 300 for configuring the approvers 190 of the particular web content portion 160. Specifically, the GUI 300 includes an approval section 302 that includes a find field 304 and a selection field 306. The user can provide input to the find field 304 (e.g., via an input device connected to the clients 135 and/or the mobile device 110) such as a name of an approver 190, and further provide input to the selection field 306 relating to the find field 304 such as a category of the input provided to the find filed 304 (such as “user”). Based on the input data, the portal 204, the web content validation module 104, or both, can configure the approvers 190 for the particular web content portion 160. For example, the template 185 (or templates 185) associated with the approver 190 (or approvers 190) determined from the user input of the find file 304 and the selection field 306 is received and/or retrieved for comparison with the template 175 of the particular web content portion 160.

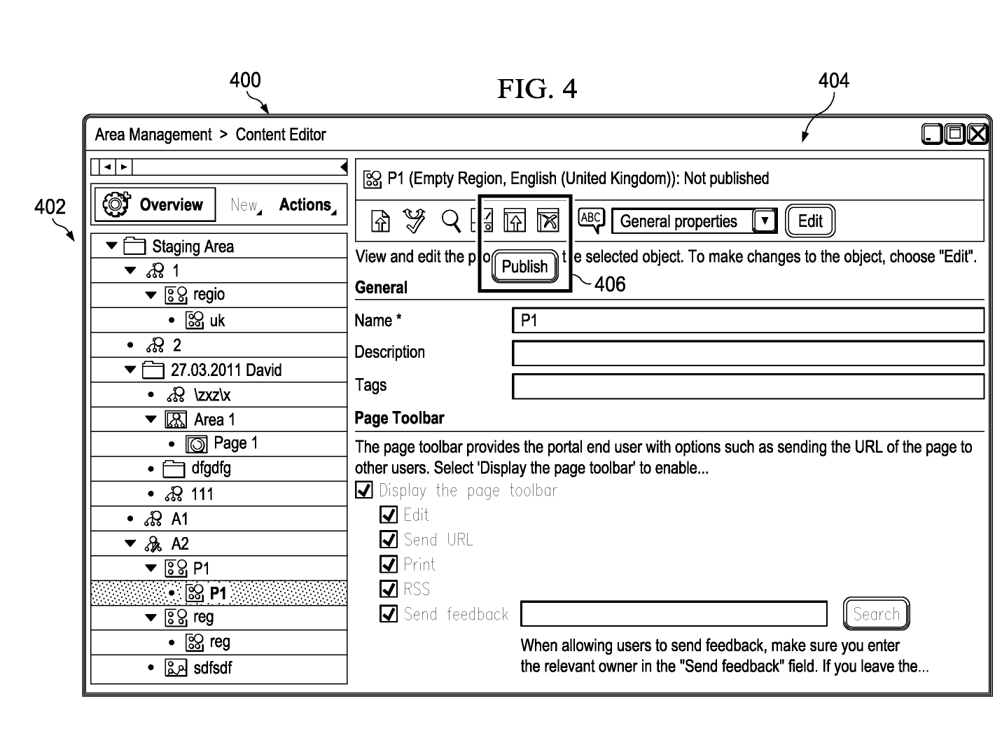

FIG. 4 illustrates an example GUI 400 for indicating approval and/or publication of the particular web content portion 160 (or the revised web content portions 220, 260). Specifically, the GUI 400 includes a staging area 402 and a content area 404, with the content area 404 including a publish action icon 406. The user can provide an indication for a desire for approval and/or publication of the particular web content portion 160 (or the revised web content portions 220, 260) by selecting the publish action icon 406 (e.g., by “clicking” the publish action icon 406). In some examples, upon selection of the publish action icon 506, the particular web content portion 160 (or revised web content portions 220, 260) are compared with a template 185 (or templates 185) associated with the user input of the find field 304 and the selection field 306 of the GUI 300 illustrated in FIG. 3. In some examples, upon selection of the publish action icon 406, the particular web content portion 160 (or the revised web content portions 220, 260) can be sent to the approver 190 (or approvers 190) associated with the user input of the find field 304 and the selection field 306 of the GUI 300 illustrated in FIG. 3.

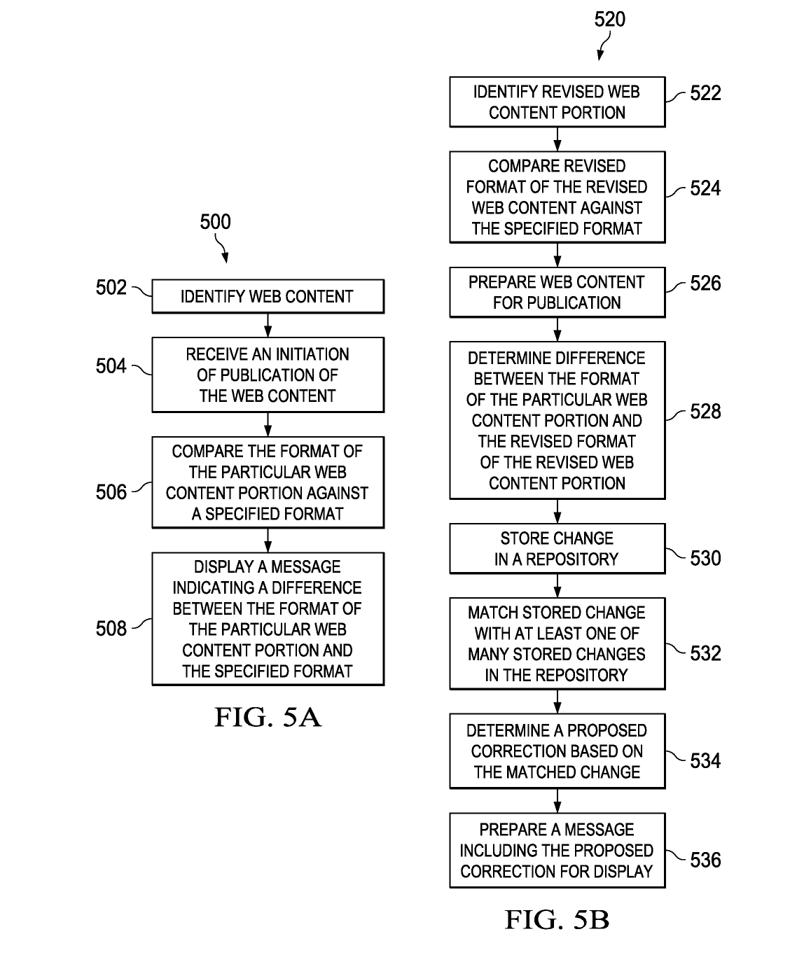

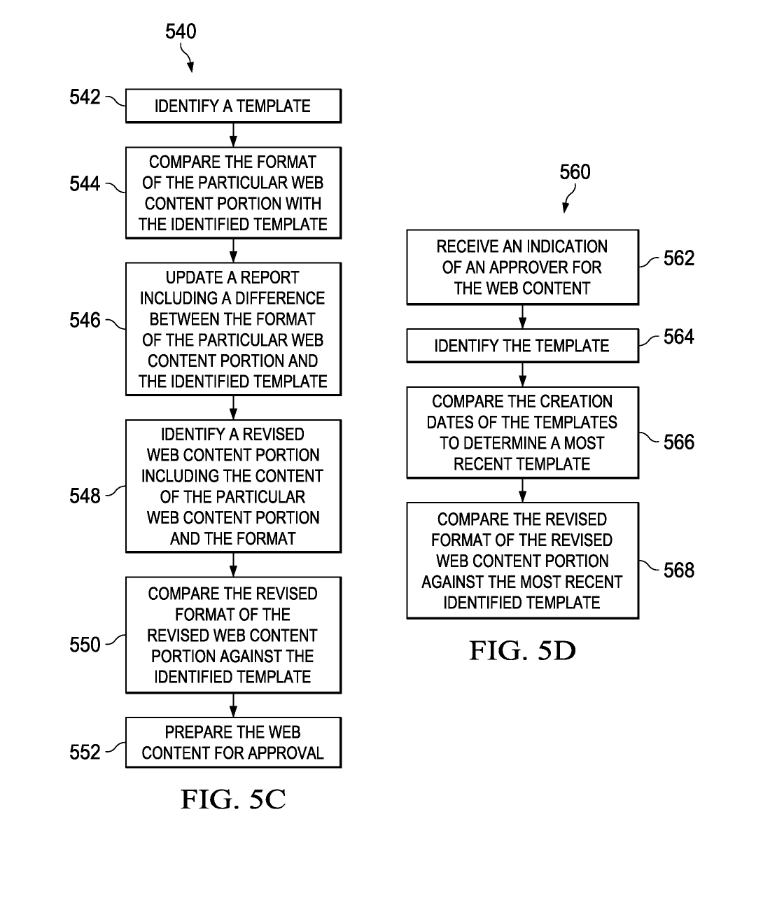

FIG. 5A illustrates an example method for validating web content. The example method 500 can be executed, for example, by the web content validation module 104, the portal 204, or both, using one or more computing devices. For example, any combination of the computing systems 102, 125, the clients 135, and the mobile device 110 can be used to execute the example process 500 and obtain any data from the memory of the mobile device 110, the computing systems 102, 125, the repository 130, and/or the clients 135.

In step 502, web content including web content portions is identified. Further, a particular web content portion of the web content includes a content and a format. For example, the web content validation module 104, the portal 204, or both, identifies the web content 150. The web content 150 includes at least a particular web content portion 160, with the particular web content portion 160 including the content 173 and the format 175. In some examples, the format 175 includes attributes 195 (e.g., a layout) such as page borders, font type, or font size.

In step 504, an initiation of publication of the web content in a web portal is received. For example, the web content validation module 104, the portal 204, or both, receives the initiation of publication of the particular web content portion 160. The initiation of publication of the particular web content portion 160 can include a user selecting the publish action icon 406 of GUI 400 illustrated in FIG. 4.

In step 506, the format of the particular web content portion is compared against a specified format. For example, the web content validation module 104, the portal 204, or both, compares the format 175 of the particular web content portion 160 against the specified format 210. In some examples, the attributes 195 associated with the format 175 and the corresponding attributes 215 associated with the specified format 210 are compared. In some examples, the specified format 210 can be based on previous actions of the user (e.g., previously reviewed (and approved) web content portions 160 submitted by the user). In some examples, the specified format 210 can be based on the template 185 associated with an approver 190. In some examples, the format 175 of the particular web content portion 160 can be compared against the specified format 210 based on receiving the initiation in step 504.

In step 508, based on the comparison including a difference between the format of the particular web content portion and the specified format, a message is displayed indicating the difference between the format of the particular web content portion and the specified format. For example, the web content validation module 104, the portal 204, or both, displays the message indicating the difference between the format 175 of the particular web content portion 160 and the specified format 210. In some examples, the difference between the format 175 and the specified format 210 can include differences between the attributes 195 associated with the format 175 and the corresponding attributes 215 associated with the specified format 210.

FIG. 5B illustrates an example method for validating web content based on previously reviewed content portions. The example method 520 can be executed, for example, by the web content validation module 104, the portal 204, or both, using one or more computing devices. For example, any combination of the computing systems 102, 125, the clients 135, and the mobile device 110 can be used to execute the example process 520 and obtain any data from the memory of the mobile device 110, the computing systems 102, 125, the repository 130, and/or the clients 135.

In step 522, a revised web content portion including the content of the particular web content portion and a revised format is identified. For example, the web content validation module 104, the portal 204, or both, identify the revised web content portion 220 that includes the revised format 225. In some examples, the revised format 225 can include (or be associated with) the attributes 230 that are based on the attributes 195 of the format 175.

In step 524, the revised format of the revised web content portion is compared against the specified format. For example, the web content validation module 104, the portal 204, or both, compare the revised format 225 of the revised web content portion 220 against the specified format 210. In some examples, the attributes 230 associated with the revised format 225 and the corresponding attributes 215 associated with the specified format 210 are compared.

In step 526, based on the comparison including a substantial match between the revised format of the revised web content portion and the specified format, the web content is prepared for publication. For example, the web content validation module 104, the portal 204, or both, prepare the revised web content portion 220 for publication.

In step 528, a difference is determined between the format of the particular web content portion and the revised format of the revised web content portion, the difference including a change to the format of the particular web content portion. For example, the web content validation module 104, the portal 204, or both, determine the difference between the format 175 of the particular web content portion 160 and the revised format 225 of the revised web content portion 220. The difference includes a change to the format 175 of the particular web content portion 160. In some examples, the change to the format 175 is based on a change to the attributes 195 associated with the format 175 to define the attributes 230 associated with the revised format 225.

In step 530, the change is stored in a repository. For example, the web content validation module 104, the portal 204, or both, store the change in a repository (e.g., the repository 130, the memory of the computing system 102 and 125, or a combination thereof). In some examples, the stored change is one of many changes stored by the repository.

In step 532, the stored change is matched with at least one of the many changes stored in the repository. For example, the web content validation module 104, the portal 204, or both, matches the stored change with one of the many changes stored in the repository. In some examples, each of the changes are associated with attributes 195.

In step 534, a proposed correction is determined based on the matched change. For example, the web content validation module 104, the portal 204, or both, determine a proposed correction based on the matched change. In some examples, for each change to the format 175, a matching change to a similar (or identical) attribute stored by the repository is determined. In some examples, the proposed correction can be a change to one of the attributes 195 of the format 175 based on the determined change such that the revised format 225 matches the specified format 210.

In step 536, a message is prepared that includes the proposed correction to send to a user. For example, the web content validation module 104, the portal 204, or both, prepare a message that includes the proposed correction to send to the user.

FIG. 5C illustrates an example method for validating web content based on a template. The example method 540 can be executed, for example, by the web content validation module 104, the portal 204, or both, using one or more computing devices. For example, any combination of the computing systems 102, 125, the clients 135, and the mobile device 110 can be used to execute the example process 540 and obtain any data from the memory of the mobile device 110, the computing systems 102, 125, the repository 130, and/or the clients 135.

In step 542, a template based on a type of the web content is identified. For example, the web content validation module 104, the portal 204, or both, identify the template 185 based on the type of the particular web content portion 160 (e.g., the content 173, the format 175, or both, of the particular web content portion 160). The template 185 can include (or be associated with) attributes 250. In some examples, the template 185 includes a XML document.

In step 544, the format of the particular web content portion is compared with the identified template. For example, the web content validation module 104, the portal 204, or both, compare the format 175 of the particular web content portion 160 with the template 185. In some examples, comparing of the format 175 of the particular web content portion 160 against the specified format 210 can include comparing one or more attributes 195 of the format 175 to one or more corresponding attributes 250 of the template 185.

In step 546, based on the comparison including a difference between the format of the particular web content portion and the identified template, a report is updated including the difference between the format of the particular web content portion and the identified template. For example, the web content validation module 104, the portal 204, or both, can update the report including a difference between the format 175 of the particular web content portion 160 and the template 185. In some examples, the difference between the format 175 and the template 185 can include differences between the attributes 195 associated with the format 175 and the corresponding attributes 250 associated with the template 185.

In step 548, a revised web content portion is identified including the content of the particular web content portion and a revised format. For example, the web content validation module 104, the portal 204, or both, identify the revised web content portion 260 that includes the content 173 of the particular web content portion 160 and a revised format 265. In some examples, the revised format 265 can include (or be associated with) attributes 270 that are based on the attributes 250 of the template 185.

In step 550, the revised format of the revised web content portion is compared against the identified template. For example, the web content validation module 104, the portal 204, or both, can compare the revised format 265 of the revised web content portion 260 against the template 185. In some examples, comparing of the revised format 265 of the revised web content portion 260 against the template 185 can include comparing one or more attributes 270 of the revised format 265 to one or more corresponding attributes 250 of the template 185.

In step 552, based on the comparison including a substantial match between the revised format of the revised web content portion and the identified template, the web content is prepared for approval. For example, the web content validation module 104, the portal 204, or both, can prepare the revised web content portion 260 for approval. In some examples, the matching between the revised format 265 and the template 185 can include matching between the attributes 270 associated with the revised format 265 and the corresponding attributes 250 associated with the template 185. In some examples, preparing for approval and/or publication of the revised web content portion 260 can include sending the revised web content portion 260 to the approver 190 (or approvers 190) associated with the template 185.

FIG. 5D illustrates an example method for identifying a template based on an approver. The example method 560 can be executed, for example, by the web content validation module 104, the portal 204, or both, using one or more computing devices. For example, any combination of the computing systems 102, 125, the clients 135, and the mobile device 110 can be used to execute the example process 560 and obtain any data from the memory of the mobile device 110, the computing systems 102, 125, the repository 130, and/or the clients 135.

In step 562, an indication of at least one approver for the web content is received. For example, the web content validation module 104, the portal 204, or both, receives the indication of at least one approver 190 for the revised web content portion 260.

In step 564, based on the at least one approver, the template is identified. For example, the web content validation module 104, the portal 204, or both, identify the template 185 based on the at least one approver 190. In some examples, the identified template 185 is one of many templates 185, with each template 185 including a creation date.

In step 566, the creation dates of the templates are compared to determine a most recent identified template. For example, the web content validation module 104, the portal 204, or both, determine a most recent template 185 from the many templates 185 (e.g., the “newest” template 185).

In step 568, the revised format of the revised web content portion is compared against the most recent identified template. For example, the web content validation module 104, the portal 204, or both, compares the revised format 265 of the revised web content portion 260 against the most recent template 185.

A number of implementations have been described. Nevertheless, it will be understood that various modifications may be made. For example, other methods described herein besides or in addition to that illustrated in FIGS. 5A-5D may be performed. Further, the illustrated steps of method 500, 520, 540, and 560 may be performed in different orders, either concurrently or serially. Further, steps may be performed in addition to those illustrated in method 500, 520, 540, and 560, and some steps illustrated in method 500, 520, 520, and 560 may be omitted without deviating from the present disclosure. Accordingly, other implementations are within the scope of the following claims.

What is claimed is:

1. A computer-implemented method for validating web content, the method comprising:
identifying web content comprising a plurality of web content portions, wherein a particular web content portion comprises a content and a format;
comparing the format of the particular web content portion against a specified format; and
based on the comparison comprising a difference between the format of the particular web content portion and the specified format, displaying a message indicating the difference between the format of the particular web content portion and the specified format.

2. The method of claim 1, further comprising:
receiving an initiation of publication of the web content in a web portal; and
based on the received initiation, initiating the comparison of the format of the web content portion against the specified format.

3. The method of claim 1, wherein the format comprises a layout of the web content portion defining at least one of page borders, font type, or font size.

4. The method of claim 1, further comprising:
identifying a revised web content portion comprising the content of the particular web content portion and a revised format;
comparing the revised format of the revised web content portion against the specified format; and
based on the comparison comprising a substantial match between the revised format of the revised web content portion and the specified format, preparing the web content for publication.

5. The method of claim 4, further comprising:
determining a difference between the format of the particular web content portion and the revised format of the revised web content portion, the difference comprising a change to the format of the particular web content portion; and
storing the change in a repository.

6. The method of claim 5, wherein the stored change is one of a plurality of changes stored in the repository, the method further comprising:
matching the stored change with at least one of the plurality of changes stored in the repository;
determining a proposed correction based on the matched change; and
preparing a message that comprises the proposed correction to send to a user.

7. The method of claim 1, wherein comparing the format of the particular web content portion against a specified format comprises:
identifying a template based on a type of the web content;
comparing the format of the particular web content portion with the identified template; and
based on the comparison comprising a difference between the format of the particular web content portion and the identified template, updating a report comprising the difference between the format of the particular web content portion and the identified template.

8. The method of claim 7, wherein the template comprises an XML document.

9. The method of claim 7, further comprising:
identifying a revised web content portion comprising the content of the particular web content portion and a revised format;
comparing the revised format of the revised web content portion against the identified template; and
based on the comparison comprising a substantial match between the revised format of the revised web content portion and the identified template, preparing the web content for approval.

10. The method of claim 9, further comprising:
receiving an indication of at least one approver for the web content;
based on the at least one approver, identifying the template.

11. The method of claim 10, wherein the identified template is one of a plurality of identified templates, and each of the plurality of identified templates comprises a creation date, the method further comprising:
comparing the creation dates of the plurality of identified templates to determine a most recent identified template; and
comparing the revised format of the revised web content portion against the most recent identified template.

12. A computer storage medium encoded with a computer program, the program comprising instructions that when executed by one or more computers cause the one or more computers to perform operations comprising:
identifying web content comprising a plurality of web content portions, wherein a particular web content portion comprises a content and a format;
comparing the format of the particular web content portion against a specified format; and
based on the comparison comprising a difference between the format of the particular web content portion and the specified format, displaying a message indicating the difference between the format of the particular web content portion and the specified format.

13. The computer storage medium of claim 12, wherein the operations further comprise:
receiving an initiation of publication of the web content in a web portal; and
based on the received initiation, initiating the comparison of the format of the web content portion against the specified format.

14. The computer storage medium of claim 12, wherein the operations further comprise:
identifying a revised web content portion comprising the content of the particular web content portion and a revised format;
comparing the revised format of the revised web content portion against the specified format; and
based on the comparison comprising a substantial match between the revised format of the revised web content portion and the specified format, preparing the web content for publication.

15. The computer storage medium of claim 14, wherein the operations further comprise:
determining a difference between the format of the particular web content portion and the revised format of the revised web content portion, the difference comprising a change to the format of the particular web content portion; and
storing the change in a repository.

16. The computer storage medium of claim 15, wherein the stored change is one of a plurality of changes stored in the repository, wherein the operations further comprise:
matching the stored change with at least one of the plurality of changes stored in the repository;
determining a proposed correction based on the matched change; and
preparing a message that comprises the proposed correction to send to a user.

17. The computer storage medium of claim 12, wherein the operation of comparing the format of the particular web content portion against a specified format further comprising:
identifying a template based on a type of the web content;
comparing the format of the particular web content portion with the identified template; and
based on the comparison comprising a difference between the format of the particular web content portion and the identified template, updating a report comprising the difference between the format of the particular web content portion and the identified template.

18. The computer storage medium of claim 17, wherein the operations further comprise:
identifying a revised web content portion comprising the content of the particular web content portion and a revised format;
comparing the revised format of the revised web content portion against the identified template; and
based on the comparison comprising a substantial match between the revised format of the revised web content portion and the identified template, preparing the web content for approval.

19. A system of one or more computers configured to perform operations comprising:
identifying web content comprising a plurality of web content portions, wherein a particular web content portion comprises a content and a format;
comparing the format of the particular web content portion against a specified format; and
based on the comparison comprising a difference between the format of the particular web content portion and the specified format, displaying a message indicating the difference between the format of the particular web content portion and the specified format.

20. The system of claim 19, wherein the operations further comprise:
identifying a revised web content portion comprising the content of the particular web content portion and a revised format;
comparing the revised format of the revised web content portion against the specified format; and
based on the comparison comprising a substantial match between the revised format of the revised web content portion and the specified format, preparing the web content for publication.

21. The system of claim 20, wherein the operations further comprise:
determining a difference between the format of the particular web content portion and the revised format of the revised web content portion, the difference comprising a change to the format of the particular web content portion; and
storing the change in a repository.

22. The system of claim 21, wherein the stored change is one of a plurality of changes stored in the repository, wherein the operations further comprise:
matching the stored change with at least one of the plurality of changes stored in the repository;
determining a proposed correction based on the matched change; and
preparing a message that comprises the proposed correction to send to a user.

23. The system of claim 20, wherein the operation of comparing the format of the particular web content portion against a specified format further comprising:
identifying a template based on a type of the web content;
comparing the format of the particular web content portion with the identified template; and
based on the comparison comprising a difference between the format of the particular web content portion and the identified template, updating a report comprising the difference between the format of the particular web content portion and the identified template.

24. The system of claim 23, wherein the operations further comprise:
identifying a revised web content portion comprising the content of the particular web content portion and a revised format;
comparing the revised format of the revised web content portion against the identified template; and
based on the comparison comprising a substantial match between the revised format of the revised web content portion and the identified template, preparing the web content for approval.
